(19) United States
(12) Patent Application Publication
(10) Pub. No.: US 2014/0304026 A1
(43) Pub. Date: Oct. 9, 2014

(54) PRODUCT LEVEL MANAGEMENT SYSTEM

(71) Applicants: Simon John Delaney, Hamilton (NZ); Craig Laurence White, Hamilton (NZ)

(72) Inventors: Simon John Delaney, Hamilton (NZ); Craig Laurence White, Hamilton (NZ)

(73) Assignee: BJ Ball Limited, Hamilton (NZ)

(21) Appl. No.: 14/124,029

(22) PCT Filed: Jun. 14, 2012
(86) PCT No.: PCT/NZ2012/000096

§ 371 Date: May 19, 2014

(30) Foreign Application Priority Data
Jun. 17, 2011 (NZ) 593549

(51) Int. Cl. G06Q 10/06; G06Q 30/06

(52) U.S. Cl. CPC G06Q 10/06315; G06Q 30/0633
USPC 705/7.25

(57) ABSTRACT

The invention relates to a product level management system, method and apparatus that enable the levels of product to be maintained through automated ordering once product levels fall below a preset level. Product usage is tracked by using a device to read a code associated with a product at the time the product is used. Product usage data is used to update product level data, which is used to determine whether more product is required. The invention also allows an audit of product levels to be conducted and the product level data to be updated as a result of the audit.

### FIELD OF INVENTION

The invention relates to a product level management system.

### BACKGROUND TO THE INVENTION

Many industries require all kinds of goods to be continually delivered to ensure the stock in those goods does not run out. Running out of stock can mean productivity decreases or stops. Companies therefore seek to put systems into place which ensure the risk of running out of essential stock items is minimised.

One industry in which the regular consignment of product is critical is the paper industry. Many companies rely on having a sufficient supply of paper to cope with needs and it can be damaging to a business if the supply of paper runs out. There are countless other examples across a vast number of industries where product must be kept in sufficient stock to maintain productivity.

Traditional consignment/stock ordering systems require a customer to order a specific amount of product, the customer having first ascertained how much product it needs. The order may be paid for in advance or after delivery. The product supplier receives the order and prepares the order for a distributor to deliver. Usually it is down to the customer to request further orders to ensure its stock is replenished or regular consignment orders intended to maintain stock levels given trends in usage may be organised.

Such systems are often reliant on the customer to complete the necessary orders to keep its own stock levels at a sufficient level. Often, the customer may fail to do so because of a breakdown in its own internal systems, lack of attention or unpredictable surges in product use. Regular consignment orders are intended to reduce the risk of low stock levels because of customer error, but they may not be sufficient to cope with suddenly high levels of product use. Furthermore, when there are periods of low product use, a regular consignment order can cause stock levels to build up, meaning stock may be purchased unnecessarily and storage costs may increase. Sometimes stock may be returned to the supplier, meaning distribution costs are increased for one or both parties.

Different types of ordering systems may involve different levels of pro-activeness on the part of the supplier or distributor to strive to ensure the customer's stock never falls below a predetermined level or increases above a predetermined level. However, there are inherent problems with communicating stock level information between organisations and also with suppliers managing orders from a number of customers simultaneously. Orders are often received on an urgent basis and a supplier may need to maintain large levels of stock to ensure it can cope with potential order peaks. Large levels of stock increases cost to the supplier, which may be passed on to its customers.

Often, some human input is required to communicate stock replenishment requirements and this can be both time consuming and costly. In some cases, an employee might need to physically count the amount of stock in order to complete an order for new stock.

Some industries have developed integrated systems to try to overcome at least some of the problems discussed above. For example, in the supermarket industry, systems have been developed in which staff in supermarkets are able to scan product that is placed on the shop floor and this information is automatically fed back to a supplier. The supplier automatically supplies additional stock if levels are getting low. Supermarkets may also use information from point-of-sale barcode scanners to monitor stock levels.

While such a system may be suitable for the supermarket industry, it may not be suitable for smaller industries or industries not already having established stock recordal systems. In particular, the need for dedicated hardware such as barcode scanners introduces a large capital expenditure for implementing an integrated consignment system which many companies would prefer to avoid.

### OBJECT OF THE INVENTION

It is an object of the invention to provide an improved product level management system.

Alternatively, it is an object to provide a product level management system that overcomes at least some of the foregoing disadvantages associated with the prior art, or at least to provide the public with a useful choice.

### SUMMARY OF THE INVENTION

According to a first aspect of the invention, there is provided a product level management system comprising:
at least one portable personal communications device configured to read a code associated with a product, generate product usage data and send the product usage data;
means for receiving the product usage data;
means for updating product level data according to the product usage data;
means for determining whether more of the product is required based on the product level data;
means for sending a product order message to a product ordering system in the event more of the product is required; and
means for receiving the product order message and subsequently creating a product order.

It will be understood that the step of reading the code includes identifying the code and decoding information stored in the code.

In one embodiment of the invention, the code is a visual code. Preferably, the portable personal communications device is configured to read the visual code in the form of a barcode, for example a quick response (QR) code.

In another embodiment of the invention, the code is associated with a code-carrying device, for example a tag, chip or the like. Preferably, the portable personal communications device is configured to read the code by means of wireless communication between the portable personal communications device and the code-carrying device, for example using near field communication (NFC) or RFID.

Preferably, the portable personal communications device is configured to display product description data for user verification.

Preferably, the portable personal communications device is configured to receive user-inputted product quantity data to generate the product usage data. More preferably, the portable personal communications device is further configured to receive reference data associated with product usage.

In preferred embodiments of the invention, the portable personal communications device is a mobile telephone.

Preferably, the product level data is stored within a first database. More preferably, the product usage data is stored within a second database. The first and second databases may or may not be the same.

Preferably, the means for determining whether more of the product is required compares the product level data with one or more predefined product level thresholds. More preferably, more of the product is required if the product level data indicates a level of the product is below the predefined product level threshold.

Preferably, the system comprises a portal for receiving the product usage data, updating product level data, determining whether more of the product is required based on the product level data and sending the product order message to the product ordering system in the event more of the product is required. The portal may comprise a processor, web server, graphical user interface (GUI) and one or more web pages.

Preferably, the system further comprises means for allowing one or more users to view and/or edit the product usage data, product level data, predefined product level thresholds, product ordering information and/or billing information. In a preferred embodiment, the means for allowing comprises the GUI. The one or more users may include product users, system administrators and product suppliers.

Preferably, the product order message comprises an XML message.

Preferably, the system further comprises means for processing the product order. The means for processing may comprise outputting details of an order, for example on a GUI or printing device.

Preferably, the product ordering system is part of an enterprise resource planning system.

In a preferred embodiment of the invention, the product level management system further comprises means to check product levels relative to product level data.

More preferably, at least one portable personal communications device is configured to generate and send actual product level data following reading a code associated with a product and the product level management system further comprises:
means for receiving the actual product level data;
means for comparing the actual product level data with stored product level data; and
means for creating and sending a product level discrepancy notification if the actual product level data differs from the stored product level data.

Preferably, the product level management system further comprises means for processing the product level discrepancy notification. The means for processing may create an invoice or credit note related to the product level discrepancy notification. Alternatively, the means for processing may create a product order corresponding to the product level discrepancy notification.

Preferably, a product level discrepancy notification is created if the actual product level data differs from the stored product level data by at least a predetermined amount.

Preferably, the product level management system further comprises means for updating the stored product level data if the actual product level data differs from the stored product level data.

According to a second aspect of the invention, there is provided a method of managing product levels comprising:
receiving product usage data generated by a portable personal communications device following reading of a code associated with a product;
updating product level data according to the product usage data;
determining whether more of the product is required based on the product level data; and
sending a product order message to a product ordering system in the event more of the product is required.

Preferably, the step of determining whether more of the product is required comprises comparing the product level data with one or more predefined product level thresholds. More preferably, more of the product is required if the product level data indicates a level of the product is below the predefined product level threshold.

Preferably, the method further comprises displaying to one or more users the product usage data, product level data, predefined product level thresholds, product ordering information and/or billing information. The method may further comprise receiving update information from the user(s) and updating one or more of the product usage data, product level data, predefined product level thresholds, product ordering information and/or billing information in accordance with the update information.

More preferably, the method further comprises:
receiving actual product level data generated by a portable personal communications device following reading of a code associated with a product;
comparing the actual product level data with stored product level data; and
creating and sending a product level discrepancy notification if the actual product level data differs from the stored product level data.

Preferably, a product level discrepancy notification is created if the actual product level data differs from the stored product level data by at least a predetermined amount.

Preferably, the method further comprises updating the stored product level data if the actual product level data differs from the stored product level data.

According to a third aspect of the invention, there is provided an apparatus for use in a product level management system, the apparatus comprising:
means for receiving product usage data generated by a portable personal communications device following reading of a code associated with a product;
means for updating product level data according to the product usage data;
means for determining whether more of the product is required based on the product level data; and
means for sending a product order message to a product ordering system in the event more of the product is required.

Preferably, the means for determining whether more of the product is required compares the product level data with one or more predefined product level thresholds. More preferably, more of the product is required if the product level data indicates a level of the product is below the predefined product level threshold.

Preferably, the apparatus further comprises means for allowing one or more users to view and/or edit the product usage data, product level data, predefined product level thresholds, product ordering information and/or billing information. In a preferred embodiment, the means for allowing comprises a GUI. The one or more users may include product users, system administrators and product suppliers.

More preferably, the apparatus further comprises:
means for receiving actual product level data generated by a portable personal communications device following reading of a code associated with a product;
means for comparing the actual product level data with stored product level data; and
means for creating and sending a product level discrepancy notification if the actual product level data differs from the stored product level data.

Preferably, a product level discrepancy notification is created if the actual product level data differs from the stored product level data by at least a predetermined amount.

Preferably, the apparatus further comprises means for updating the stored product level data if the actual product level data differs from the stored product level data.

According to a fourth aspect of the invention, there is provided the use of a product level management system according to the first aspect of the invention to perform a method of managing product levels according to the second aspect of the invention.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings, in which:

FIG. 1 is an illustration of a product level management system according to one embodiment of the invention;

FIG. 2 is a flow chart showing a method of managing product levels according to an embodiment of the invention;

FIG. 3 is an illustration of an administration portal webpage according to one embodiment of the invention;

FIG. 4 is an illustration of an administration portal webpage according to another embodiment of the invention;

FIGS. 5 to 9 are illustrations of mobile phone screens according to various embodiments of the invention;

FIGS. 10 and 11 are illustrations of administration portal webpages according to further embodiments of the invention;

FIG. 12 is a flow chart showing a method of auditing product levels according to an embodiment of the invention; and

FIG. 13 is an illustration of a mobile phone screen according to another embodiment of the invention.

### DETAILED DESCRIPTION OF PREFERRED EMBODIMENTS OF THE INVENTION

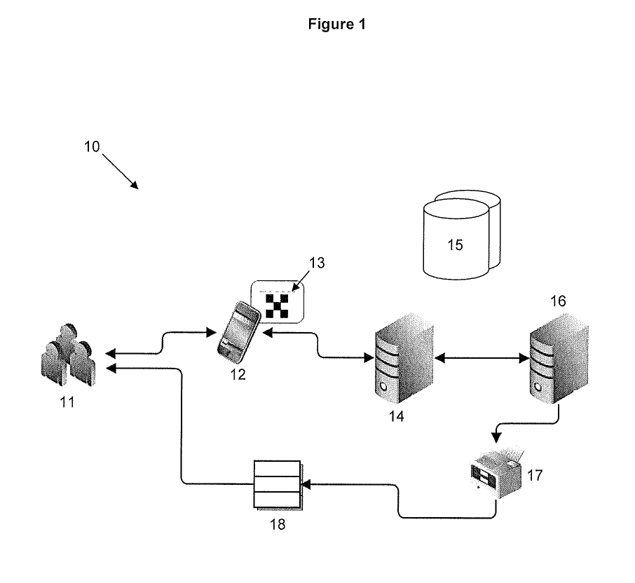

FIG. 1 is an illustration of a product level management system 10 according to one embodiment of the invention. System 10 comprises customers 11 who are supplied with product managed by the system. Customers 11 have at least one portable personal communications device 12. Communications device 12 is configured to read a visual code 13, generate data accordingly and be able to send the generated data.

In a preferred embodiment of the invention, communications device 12 is a mobile telephone having a camera and being able to connect to the Internet. For example, communications device 12 could be a smartphone such as an iPhone. Other embodiments include other types of communications device having the necessary functionality, such as other types of mobile telephone, personal digital assistants (PDAs) and tablet computers.

In the preferred form of the invention, communications device 12 is configured to read a visual code 13 in the form of a quick response (QR) code. A QR code can be read by the communications device, for example using its built-in camera, and data can be generated as a result. A mobile phone with a camera can be configured to read a QR code by installing the appropriate application. Although QR codes are used in the preferred embodiment of the invention, it will be understood that any form of readable code may be used. This includes barcodes and alphanumeric codes.

In another embodiment of the invention the code is in a form readable by a wireless communications device using, for example near field communication (NFC) or RFID communication standards. For example, the code may be associated with a code-carrying device such as a tag, chip or other device which is configured to be read by a communications device configured to read the code according to the necessary communications standard. In one embodiment, a smartphone is configured as an NFC device and is able to read an NFC chip, which is associated with a certain product in the product level management system, as will be described below.

One advantage of using NFC or another form of wireless communication to read a code associated with product over a visual code is that, using NFC, the reader device simply needs to be located close enough to the tag device for the reader to read the code. In contrast, to read a visual code such as a QR code requires the reader device to be positioned such that the device can read the code, for example by pointing a camera at the code. This may require more care to be taken by the user, for example to ensure the camera is correctly aligned and in focus. As a result, the use of visual codes may be more prone to human error and increase the time taken to read codes.

However, for the purposes of the remaining description, the system will be described in relation to its use with QR codes as the readable codes. The skilled addressee will understand that, whichever type of code is used, the rest of the system may still function as is described. For example, upon reading an NFC tag, an NFC device may be configured to respond in the same way as is described below in relation to QR codes.

System 10 further comprises an administration portal 14 which, in the preferred embodiment of the invention, comprises the ability to receive, send, process and display data and allow users to interact with that data, for example through a plurality of web pages or a software application. Suitable architecture enabling such functionality will be apparent to those of skill in the art, but may include at least one processor, a web server and/or graphical user interface (GUI) for displaying one or more web pages. Apparatus 14 is adapted to receive data from communications device 12 either directly or indirectly, for example by being connected to the Internet. Administration portal 14 may be controlled by users through the graphical user interface (GUI), for example to control the processor and/or web server and to access data stored in one or more databases 15.

Product level management system 10 further comprises product ordering system 16 which controls ordering of the product managed by the management system. Product ordering system 16 is able to receive orders for products and process the orders according to requirements. Product ordering system is connected to databases 15 and administration portal 14. In a preferred embodiment of the invention, product level management system 10 is an enterprise resource planning (ERP) system. Many types of ERP system will be familiar to those of skill in the art. The system according to the invention is advantageously intended to incorporate existing ERP systems, thus enabling it to be easily built to function with established infrastructure and business processes.

System 10 further comprises means for processing a product order 17. In one embodiment of the invention, the means for processing comprises an output device, such as a printer or GUI by which users are able to view pending orders and action them. The means for processing a product order 17 may be interpreted more broadly in other embodiments of the invention, for example including parts of a product management system and/or resources used to issue, manage, prepare and/or deliver orders.

In the embodiment of the invention shown in FIG. 1, system 10 further comprises delivery means 18. Delivery means 18 may comprise a delivery vehicle or any suitable method by which product can be delivered to customers 11.

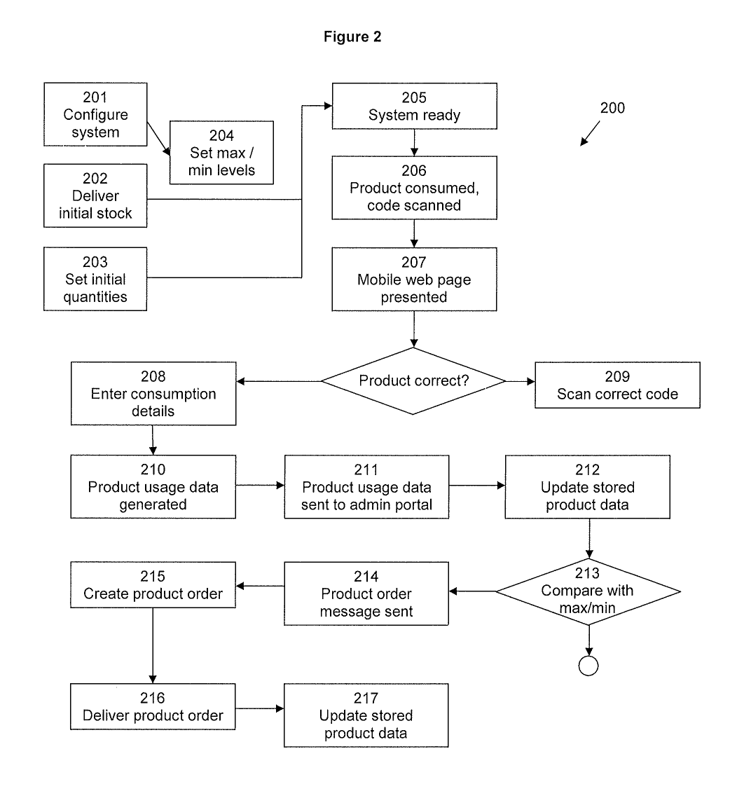

Use of the product level management system described in FIG. 1 will now be explained with reference to FIG. 2, which is a flow chart showing a method of managing product levels 200 according to an embodiment of the invention. For the purposes of the following description, the invention will be described with reference to the management of paper stock levels at a company that regularly consumes paper. However, it will be understood that this description is by way of example only, and the invention is not limited to the supply of any particular type of product.

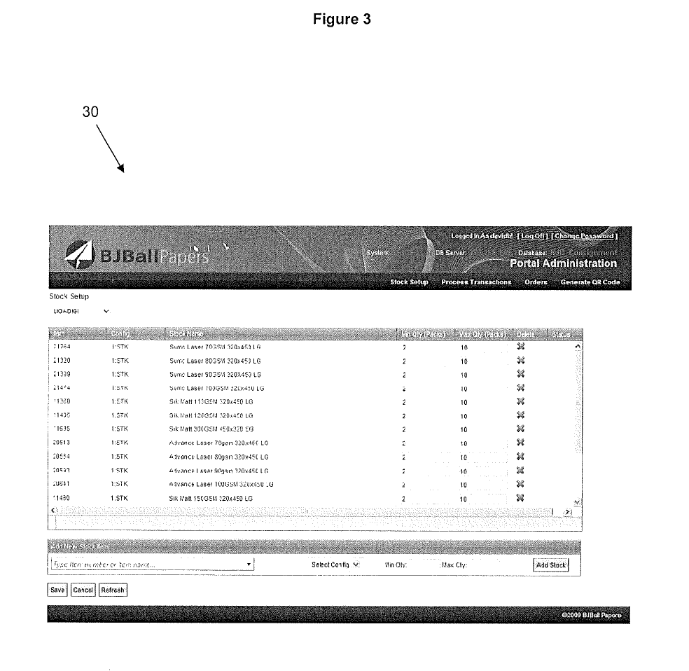

Before product levels can be managed the product level management system needs to be set up. At step 201, the product level management system is configured for a new customer 11. This includes providing access to the management system for the customer and its employees, including the creation of user profiles and access privileges. Details of one or more product lines to be managed using the system are also entered. For example, A4 paper and A3 paper product lines are set up. FIG. 3 is an illustration of an administration portal webpage 30 according to one embodiment of the invention. Webpage 30 allows supplier staff to set up product lines in the system.

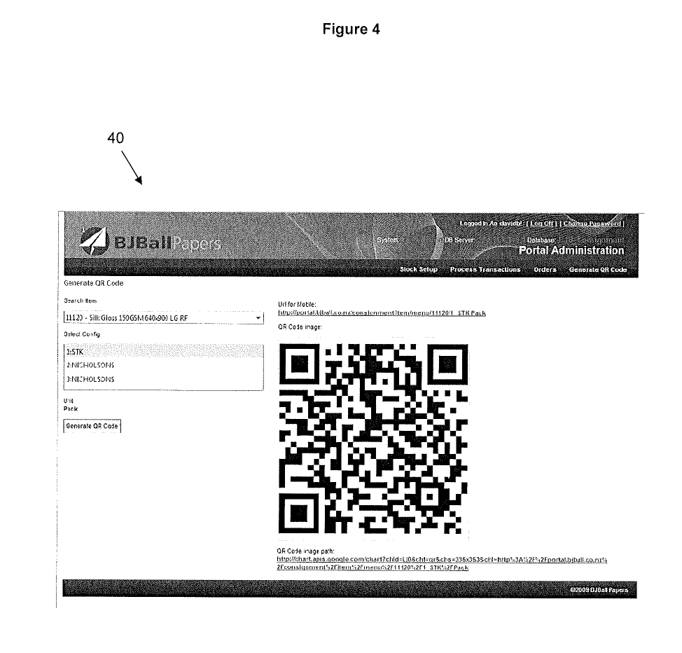

Step 201 further comprises generating QR codes corresponding to the product line or lines to be managed. This step is also carried out using administration portal 14. FIG. 4 is an illustration of an administration portal webpage 40 according to one embodiment of the invention. Webpage 40 allows an administrator to generate a QR for a particular product line. The generated QR code can be provided in a printable format. Webpage 40 also generates the web address associated with the QR code and hence the product line.

At step 202, product stock is delivered to the customer 11, for example using delivery vehicle 18. In the example, initial quantities of A4 and A3 paper are delivered to the customer and stored in a convenient location. QR codes 13 corresponding to the product lines are located proximate to the location of the paper where it will be consumed in a position that is convenient for scanning by the customer's employees who will use the paper.

At step 203, the quantities of A4 and A3 paper delivered to the customer are entered into the system, for example through administration portal 14. The product level management system needs the initial product levels inputted to be able to manage product levels as product is consumed and product usage is recorded.

At step 204, the customer decides maximum and minimum quantity levels for the product lines and these are inputted to the system through the administration portal. The maximum and minimum quantity levels for the product define the maximum and minimum amounts respectively of that product desired to be at the customer's premises at any one time. These levels are typically decided by the customer based on a number of factors, such as expected product usage amounts and rates, product costs and the criticality of product levels to a business operation. Referring again to FIG. 3, webpage 30 allows supplier staff to enter and save maximum and minimum quantity levels for different product lines.

At step 205, the product level management system is configured and ready for use by the customer. It will be appreciated that the setup steps may be performed in a number of orders and the ordering of method steps in the description above is not limiting to the invention.

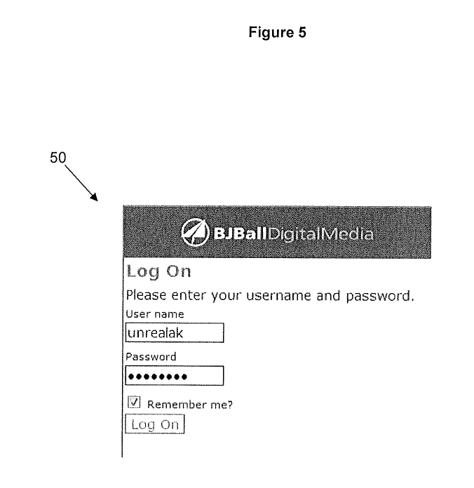

At step 206, a customer 11 consumes some product. For example, an employee of the customer may take some paper from the stock of paper stored at the customer's premises. At the same time that paper is taken, the employee uses their mobile telephone 12 and scans the QR code 13 located proximate to the paper and corresponding to the type of paper consumed. The employee is prompted for a username and password so that the product consumption event can be tracked and the employee identified. FIG. 5 is an illustration of a mobile phone screen 50 according to one embodiment of the invention. After the employee has logged in once they preferably do not have to re-enter their username and password for subsequent transactions on the same day.

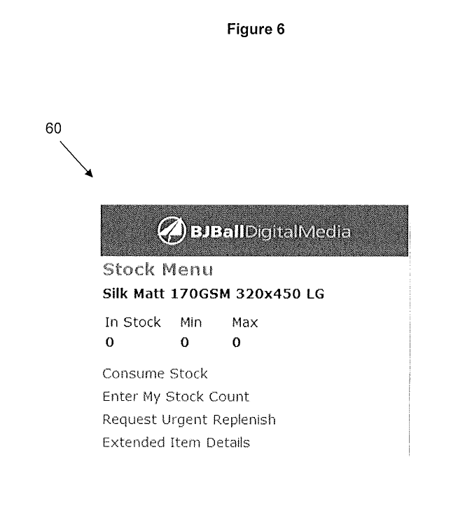

At step 207, the QR code directs the employee's mobile phone to a web page that confirms the description and quantity of paper that corresponds to the QR code scanned by the employee. FIG. 6 is an illustration of a mobile phone screen 60 according to one embodiment of the invention. Screen 60 is displayed once a QR code is scanned. It shows information on the scanned product, for example its description and the current stock level. The screen also provides a number of options for continuing.

If the description does not match the product taken, the employee can scan the correct QR code at step 209.

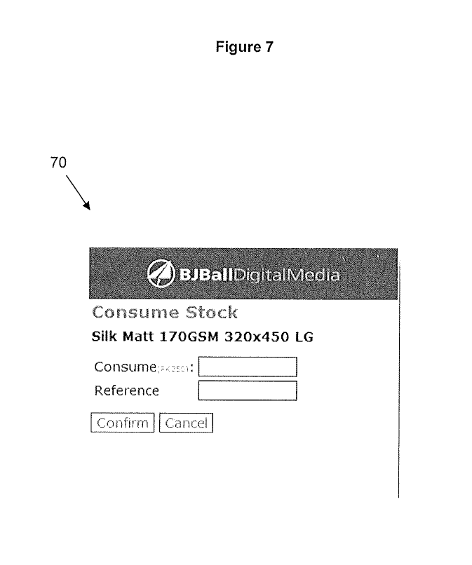

If the description of the product is correct, the employee can select a “consume stock” option from screen 60. FIG. 7 is an illustration of a mobile phone screen 70 according to one embodiment of the invention. Screen 70 is shown following selection of the “consume stock” option on screen 60 and includes text fields allowing, at step 208, the consumption quantity and a transaction reference to be entered.

The system may be configured such that on scanning of the QR code a default unit of product is assumed to have been taken. For example, in the case of paper, a unit of product may comprise a ream. If an employee takes more than one ream then they need to input the correct quantity through their mobile phone. The default unit of product may be changeable through the administration portal 14, as required. Alternatively, there is no default and a quantity of product must always be entered. Multiple QR codes may be generated for each product line, each QR code corresponding to a different unit of product. The system may also include a default unit setting in case QR codes are scanned that do not correlate to a particular unit of product.

Also at step 208, the employee may be able to enter a reference, typically an alphanumeric reference on screen 70. The reference may, for example, be used to track and monitor usage of the product or assign the consumption to a particular team, project or job code. An organisation may decide to make it compulsory to enter a reference to record and monitor product usage. In the product level management system, the reference is stored together with details of the corresponding recordal of product usage event triggered by scanning a QR code.

At step 210, mobile phone 12 generates product usage data which comprises details of the product used, the quantity used and may also comprise the reference.

At step 211, the product usage data is sent by mobile phone 12 to administration portal 14, for example over the Internet. Administration portal 14 receives the product usage data and may store the data in a database 15.

At step 212, stored product level data is updated based on the product usage data. For example, if the system has on record that there were 100 reams of A4 paper at the customer's premises and then it receives data that 8 reams of A4 paper were taken, the A4 paper level data is updated to show on 92 reams of A4 paper left.

At step 213, the system compares the stored product quantity data with the maximum and minimum quantity levels previously inputted. If the level of product is above the minimum quantity level then it is determined that no more product is required. If the level of product is below the minimum quantity level then it is determined that more product is required. In some embodiments of the invention, if the product quantity level is above the maximum quantity level then this may lead to product being returned from the customer.

If it is determined that more product is required then, at step 214, a product order message is sent by administration portal 14 to product ordering system 16. The product order message may comprise an XML message.

At step 215, product ordering system 16 receives the product order message and creates a product order. For example, the product order may be outputted on printer 17 where it is picked up by delivery staff and the product order prepared for delivery. The amount of product ordered may depend on the product line and/or the settings placed by the customer. For example, the customer of paper may establish that, as soon as A4 paper levels fall below 50 reams, a delivery which represents the difference between the agreed maximum quantity level and the quantity of reams still available should be made.

At step 216, delivery of the product order to customer 11 is made. For example, delivery vehicle 18 may convey 100 reams of A4 paper to the customer's premises.

At step 217, which may occur simultaneously with or before any of steps 214 to 216, the system updates stored product quantity level data according to the delivery of product made. For example, if the system has recorded that there are 48 reams of A4 paper at the customer's premises, thus prompting a delivery of 100 further reams, then once those reams have been delivered, the system is updated to record 148 reams of A4 paper now at the customer's premises. The system may include means by which the customer can acknowledge receipt of product and the database may not be updated until the customer's acknowledgement is received.

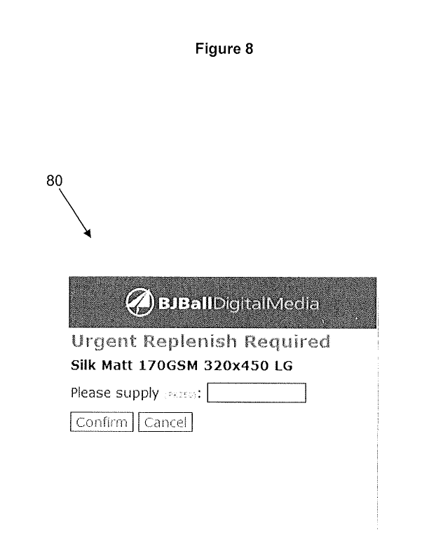

Customer employees may also be able to urgently request a product replenishment if product levels are unexpectedly or suddenly low. Screen 60 shown in FIG. 6 allows a user to select “request urgent replenishment” after scanning the relevant QR code. FIG. 8 is an illustration of a mobile phone screen 80 displayed once this option is selected according to one embodiment of the invention. Screen 80 allows a user to enter a quantity of the product line urgently required. This information is sent to the administration portal and an urgent product delivery request is created.

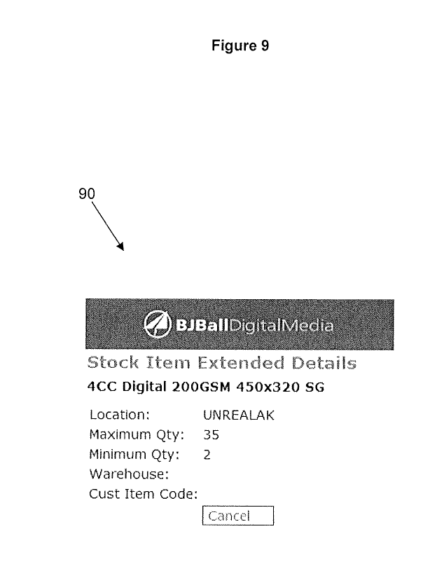

Screen 60 shown in FIG. 6 also allows a user to select “extended item details” in which further details of a particular product are provided. FIG. 9 is an illustration of a mobile phone screen 90 displayed once this option is selected according to one embodiment of the invention. Screen 90 provides further details of a product line, including its location, maximum and minimum allowed quantity levels and other details.

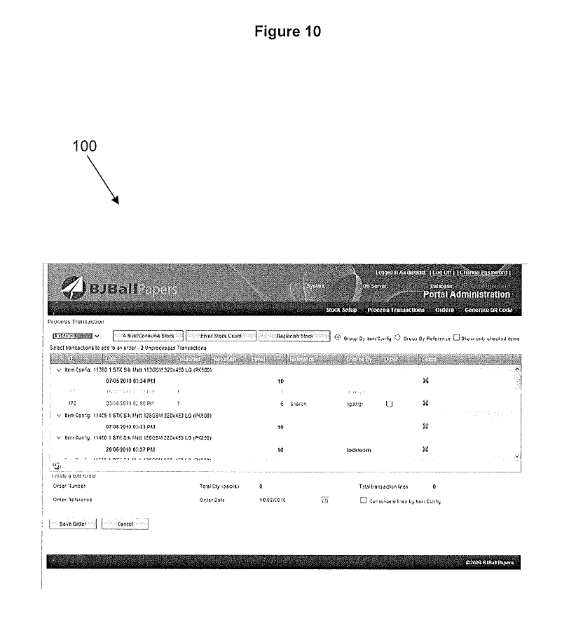

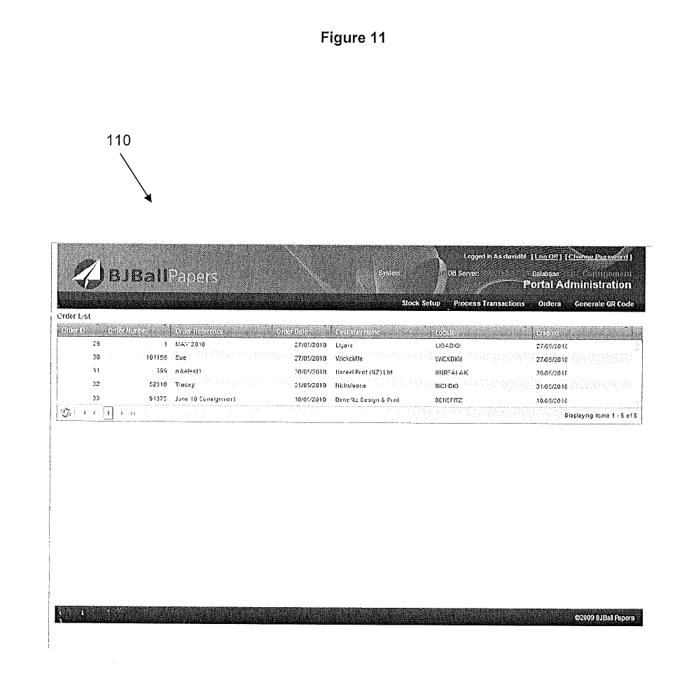

The administration portal enables suppliers to view or edit data and create product order requests if more or less product is required than would be delivered during the ordinary course of running the system. FIG. 10 is an illustration of an administration portal webpage 100 according to an embodiment of the invention. Webpage 100 shows product usage transactions and allows an order request to be prepared if necessary. Webpage 100 further allows supplier staff to consume or set stock count and to record stock replenishments. FIG. 11 is an illustration of an administration portal webpage 110 according to an embodiment of the invention. Webpage 110 allows supplier staff to view details of historic order requests and make any edits that may be required.

The product ordering system preferably interfaces with the supplier's invoicing system such that the customer can be billed for all new product orders. The customer may be billed on a regular basis or on a “by order” basis, as required. Invoicing information and historical ordering records are preferably made available to both customer and supplier through the administration portal. Such records are preferably password protected. In one embodiment, invoices are calculated as the sum of transactions within an agreed period. It is desirable that the creation of invoices in the product order system is initiated by an output from the product level management system.

It is desirable to store records of all transactions involving product in the product level management system so that any discrepancies or disputes can be corrected quickly and easily. From time to time it may be desirable for a customer or supplier to perform a stock take or audit of product and update the records based on any discrepancies found.

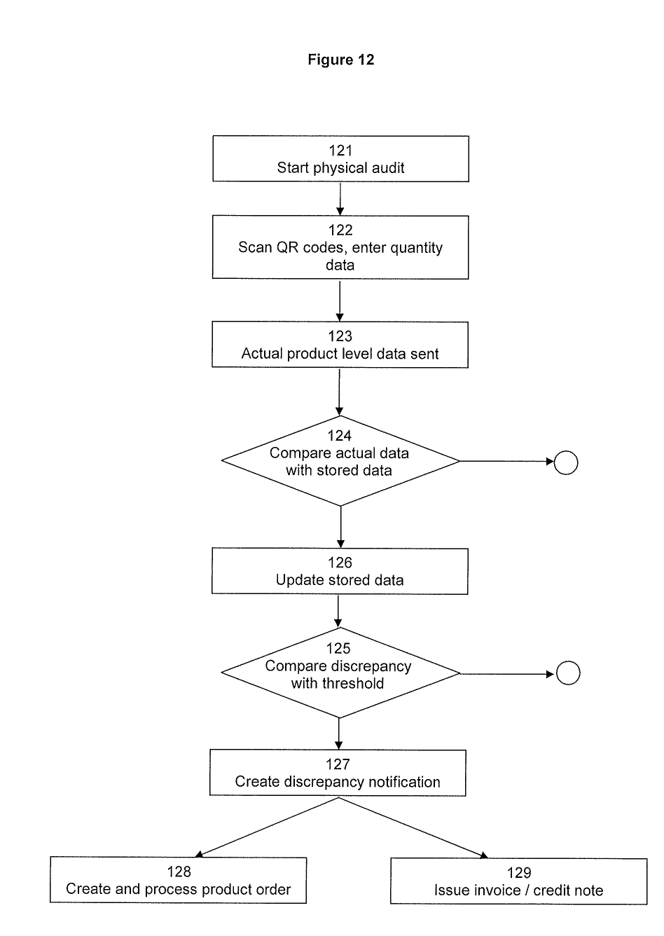

FIG. 12 is a flow chart showing a method of auditing product levels 120 according to an embodiment of the invention.

At step 121, the customer or the supplier performs a physical audit of product at the customer's premises. For example, the customer counts the number of reams of A4 and A3 paper in its paper store room.

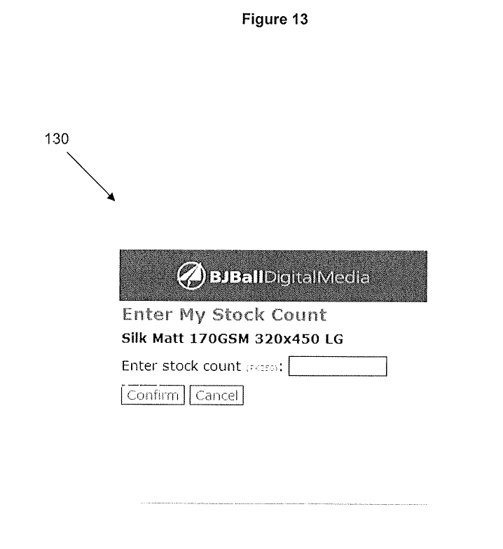

At step 122, the QR code corresponding to each product line is scanned using a compatible personal communications device and the actual quantity of product (actual product level) at the customer premises identified in the physical audit is entered. FIG. 13 is an illustration of a mobile phone screen 130 according to one embodiment of the invention. Screen 130 allows an employee to enter the actual product level/actual stock count information. This can be used for audit purposes or to check the stock levels in the management system are correct. Employees may be required to do this on each consumption event, periodically, or not at all.

At step 123, the actual product level data entered into the communications device is sent to the administration portal.

At step 124, the system compares the actual product level data received with product level data stored in database(s) 15.

If no discrepancy between the actual product level data and the stored product level data is identified then the system's records are correct and the audit is complete.

If a discrepancy is found between the actual product level data and the stored product level data, the administration portal may compare the level of discrepancy with a predetermined discrepancy threshold amount at step 125. The predetermined discrepancy threshold may have previously been identified by the customer and/or supplier and entered into the system. If the discrepancy is below the threshold amount, then it may be deemed insignificant and not worthy of further investigation or settlement. However, if the discrepancy is above the threshold amount, then it may be necessary to sort out.

In either case, if a discrepancy is identified, the data stored in the system is preferably updated at step 126. This may occur automatically or manually through the administration portal.

If a discrepancy is identified and further action is required, a discrepancy notification may be created at step 127. The discrepancy notification may be sent to a means for processing the discrepancy notification, which may comprise the product ordering system and/or the supplier's ERP system, such that a further product order may be processed (step 128) and/or an invoice or credit note may be issued (step 129), depending on whether the customer is in surplus or deficit of product.

A product level management system according to embodiments of the invention provides several advantages to both the customer and supplier over existing solutions, including but not limited to:
The system can be implemented using low cost technology that is commonly available and typically already utilised by customers. For example, smartphones can be supplied and supported at lower cost than dedicated barcode scanners and many employees may already have a smartphone that can be configured to be compatible with the system.
Customers have greater certainty that they will have sufficient stock of vital products.
Many parameters, for example replenishment frequency, invoice frequency, maximum and minimum product levels, can be specified by the customer according to its requirements. The parameters can also be altered at any time using the administration portal.
Delivery costs are reduced since fewer separate deliveries need to be made and resource planning is made easier.
The system's ability to provide detailed reports including consumption tracking allows accurate forecasting and workflow analysis.
Suppliers may need fewer resources because the system allows customers to manage their own stock levels and there is less need for direct customer communication.
At the same time, a supplier may be able to supply products to more customers because of the savings in customer contact resources and the better ability to manage product supply levels.
Deliveries to customers can be consolidated, leading to reduced transactional costs.
The system can interface with existing systems, such as ERP systems using standard EDI functionality.

In one alternative embodiment of the invention, the portable communications device sends product usage data in the form of a message, e.g. an SMS message. This is received by an SMS message receiving means of the supplier, who is thus notified of a product usage event and can assess whether further product is required. In alternative embodiments of the invention, one or more of the assessment steps may be carried out manually.

In more general terms, the invention is not limited to a fully automated process but also covers embodiments in which one or more steps of the invention may be carried out manually, for example, product usage data or product level data may be entered into the administration portal manually. Embodiments including some manual steps may be desirable in some circumstances, for example in organisations not wanting or unable to use an administration portal provided over the Internet.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. A product level management system comprising:
a memory configured to store product level data relating to product stored at a plurality of locations;
a plurality of portable personal communications devices configured to read a code associated with a product, generate product usage data and send the product usage data, wherein the product usage data includes product location data;
a processor configured to:
receive the product usage data;
update the product level data according to the product usage data;
determine whether more of the product is required based on the product level data; and
send a product order message in the event more of the product is required; and
a product ordering system configured to receive the product order message and subsequently creating a product order.

2. A product level management system as claimed in claim 1, wherein the portable personal communications device is configured to read a visual code.

3. A product level management system as claimed in claim 1, wherein the portable personal communications device is configured to read a code associated with a code-carrying device by means of wireless communication between the portable personal communications device and the code-carrying device.

4. A product level management system as claimed in claim 1, wherein the portable personal communications device is configured to display product description data for user verification.

5. A product level management system as claimed in claim 1, wherein the portable personal communications device is configured to receive user-inputted product quantity data to generate the product usage data.

6. (canceled)

7. (canceled)

8. A product level management system as claimed in claim 1, wherein the processor is configured to determine whether more of the product is required by comparing the product level data with one or more predefined product level thresholds.

9. (canceled)

10. (canceled)

11. A product level management system as claimed in claim 1, wherein the processor is further configured to allow one or more users to view and/or edit the product usage data, product level data, predefined product level thresholds, product ordering information and/or billing information.

12. (canceled)

13. (canceled)

14. (canceled)

15. (canceled)

16. A product level management system as claimed in claim 1, wherein at least one portable personal communications device is configured to generate and send actual product level data following reading a code associated with a product and the processor is further configured to:
receive the actual product level data;
compare the actual product level data with stored product level data; and
create and send a product level discrepancy notification if the actual product level data differs from the stored product level data.

17. (canceled)

18. A product level management system as claimed in claim 16, wherein a product level discrepancy notification is created if the actual product level data differs from the stored product level data by at least a predetermined amount.

19. A product level management system as claimed in claim 16, wherein the processor is further configured to update the stored product level data if the actual product level data differs from the stored product level data.

20. A method of managing product levels comprising:
receiving product usage data generated by a portable personal communications device following reading of a code associated with a product, wherein the product usage data includes the product location data;
updating product level data according to the product usage data;
determining whether more of the product is required based on the product level data; and
sending a product order message to a product ordering system in the event more of the product is required.

21. A method of managing product levels as claimed in claim 20, wherein the step of determining whether more of the product is required comprises comparing the product level data with one or more predefined product level thresholds.

22. (canceled)

23. (canceled)

24. (canceled)

25. A method of managing product levels as claimed in claim 20, wherein the method further comprises:
receiving actual product level data generated by a portable personal communications device following reading of a code associated with a product;
comparing the actual product level data with stored product level data; and
creating and sending a product level discrepancy notification if the actual product level data differs from the stored product level data.

26. A method of managing product levels as claimed in claim 25, wherein a product level discrepancy notification is created if the actual product level data differs from the stored product level data by at least a predetermined amount.

27. A method of managing product levels as claimed in claim 25, wherein the method further comprises updating the stored product level data if the actual product level data differs from the stored product level data.

28. An apparatus for use in a product level management system for managing product levels of product stored at a plurality of locations, the apparatus comprising a processor configured to:
receive product usage data generated by a portable personal communications device following reading of a code associated with a product wherein the product usage data includes product location data;
update product level data according to the product usage data;
determine whether more of the product is required based on the product level data; and
send a product order message to a product ordering system in the event more of the product is required.

29. An apparatus for use in a product level management system as claimed in claim 28, wherein the processor is configured to determine whether more of the product is required by comparing the product level data with one or more predefined product level thresholds.

30. (canceled)

31. (canceled)

32. An apparatus for use in a product level management system as claimed in claim 28, wherein the processor is further configured to:
receive actual product level data generated by a portable personal communications device following reading of a code associated with a product;
compare the actual product level data with stored product level data; and
create and send a product level discrepancy notification if the actual product level data differs from the stored product level data.

33. An apparatus for use in a product level management system as claimed in claim 32, wherein a product level discrepancy notification is created if the actual product level data differs from the stored product level data by at least a predetermined amount.

34. An apparatus for use in a product level management system as claimed in claim 32, wherein the processor is further configured to update the stored product level data if the actual product level data differs from the stored product level data.

35. (canceled)
